(19) United States
(12) Patent Application Publication
(10) Pub. No.: US 2017/0332439 A1
(43) Pub. Date: Nov. 16, 2017

(54) EXTENDING THE RANGE OF MESH NETWORKS

(71) Applicant: Nokia Technologies Oy, Espoo (FI)

(72) Inventors: Teemu SAVOLAINEN, Espoo (FI); Bilhanan SILVERAJAN, Kangasala (FI)

(73) Assignee: Nokia Technologies Oy, Espoo (FI)

(21) Appl. No.: 15/533,603

(22) PCT Filed: Dec. 11, 2014
(86) PCT No.: PCT/US2014/069819

§ 371 Date: Jun. 6, 2017

(51) Int. Cl. H04W 84/18; H04L 12/24; H04W 40/24; H04L 12/755

(52) U.S. Cl. CPC H04W 84/18; H04W 40/24; H04L 41/12; H04L 45/021

(57) ABSTRACT

In some example embodiments there is provided a method. The method may include detecting, by a router coupling a first mesh network to at least one other mesh network, a mesh packet having a destination node in the at least one other mesh network; receiving, at the router, an internet protocol address of at least one other router, wherein the internet protocol address is received in response to querying for the destination node; and sending, by the router, the mesh packet encapsulated with the internet protocol address of the at least one other router coupled to the at least one other mesh network including the destination node.

### FIELD

The subject matter described herein relates to mesh networks.

### BACKGROUND

Mesh networks are increasingly being deployed. The phrase “mesh network” refers to a network topology in which each node in the mesh can relay data for the mesh. Messages or packets can be propagated through the mesh using a variety of techniques, including flooding, path-based routing, and/or the like. In some implementations, the mesh network may route packets based on internet protocol (IP) addressing, while other mesh networks may choose to not implement IP addressing in order to save the overhead associated with IP.

### SUMMARY

In some example embodiments there is provided a method for extending the range of mesh networks.

In some example embodiments, there may be provided a method which may include detecting, by a router coupling a first mesh network to at least one other mesh network, a mesh packet having a destination node in the at least one other mesh network; receiving, at the router, an internet protocol address of at least one other router, wherein the internet protocol address is received in response to querying for the destination node; and sending, by the router, the mesh packet encapsulated with the internet protocol address of the at least one other router coupled to the at least one other mesh network including the destination node.

In some variations, one or more of the features disclosed herein including the following features can optionally be included in any feasible combination. The mesh packet may traverse the first mesh network based on an identifier identifying the node, rather than an internet protocol address. The identifier may include at least one of a universally unique identifier, a media access control address, a shared key, or a personal area network identifier. The sending the mesh packet encapsulated with the internet protocol address may include sending, via an internet protocol, the encapsulated mesh packet to the at least one other router. The router may query at least one other router to determine the destination node. The router may encapsulate the mesh packet by adding the internet protocol address of the at least one other router. The internet protocol address of the at least one other router may be received via a domain name system reply. The query may include sending a domain name system query including an identifier for the destination.

The above-noted aspects and features may be implemented in systems, apparatuses, methods, and/or computer-readable media depending on the desired configuration. The details of one or more variations of the subject matter described herein are set forth in the accompanying drawings and the description below. Features and advantages of the subject matter described herein will be apparent from the description and drawings, and from the claims. In some exemplary embodiments, one of more variations may be made as well as described in the detailed description below and/or as described in the following features.

### DESCRIPTION OF DRAWINGS

In the drawings,

FIG. 1 depicts an example of a system including nodes in a mesh network, in accordance with some example embodiments;

FIG. 2 depicts another example of a system including nodes in mesh network segments, in accordance with some example embodiments;

FIG. 3 depicts a signaling diagram between nodes and routers, in accordance with some example embodiments;

FIG. 4 depicts an example of a process for a router, in accordance with some example embodiments;

FIG. 5 depicts an example of another process for a router, in accordance with some example embodiments;

FIG. 6 depicts an example of a process for detecting a remote router, in accordance with some example embodiments; and

FIG. 7 an example of an apparatus, in accordance with some example embodiments.

Like labels are used to refer to the same or similar items in the drawings.

### DETAILED DESCRIPTION

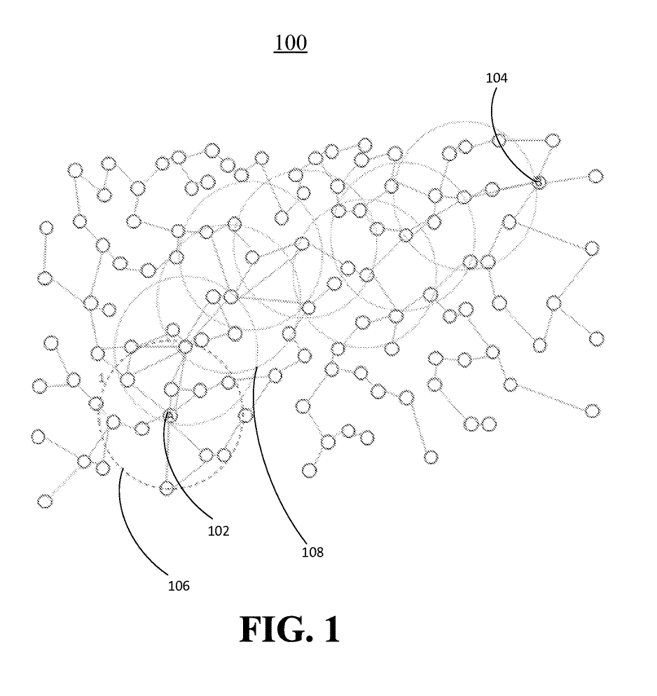

FIG. 1 depicts an example of a network 100 including one or more nodes (depicted by the small circles) including node A 102 and node B 104. In the example of FIG. 1, node A 102 may send a packet to node B 104 via mesh network 100.

In IP-based network routing, nodes A and B are identified by their IP addresses. In a connected mesh network, node A 102 may send a packet to node B 104, but the packet may be forwarded towards node B by those intervening nodes that are on a path that leads to node B 104. As such, the connected IP mesh network may require more signaling traffic for maintaining mesh topology path information used for forwarding decisions, when compared to a non-connected mesh network.

Although the paths in a connected mesh network may be established based on IP, other identifiers may be used to identify the nodes to enable routing based on the identifiers. Examples of node identifiers include a Universally Unique Identifier (UUID), a shared key, a Media Access Control (MAC) address, and a Personal Area Network (PAN) identifier. A mesh network may not maintain mesh topology path information, but instead nodes in the mesh may repeat messages they receive and thus help forward messages. For example, when node A 102 sends a packet to node B 104, the nodes within region 106 (indicated by the dashed circular region for example) forward (for example, relay) the packet, while nodes in region 108 may receive the packet and forward the packet as well. Moreover, a node may be configured to forward the packet once, even if the nodes receive the packet many times in order to reduce congestion in the mesh network 100. In any case, the nodes of mesh network 100 may relay the packet until the packet reaches node B 104 (and/or a hop limit is reached). As the number of nodes in mesh network 100 increases, the noise and/or congestion due to for example repeated forwarding and thus retransmission of the packet may become excessive and saturate network 100 with excessive duplicate packets. As noted, a hop count limit may be used to reduce this noise/congestion. Moreover, the size of the mesh network 100 may be limited as well to reduce the noise/congestion.

In some example embodiments, there is provided a mechanism for sending packets among non-IP based networks including mesh network segments.

In some example embodiments, non-IP based mesh networks may be segmented, and IP-based routers may be used to couple the non-IP based mesh network segments. Moreover, the mesh network segments may be implemented, in some example embodiments, in a non-connected mode, so packets are forwarded in the mesh network without regard to determined paths.

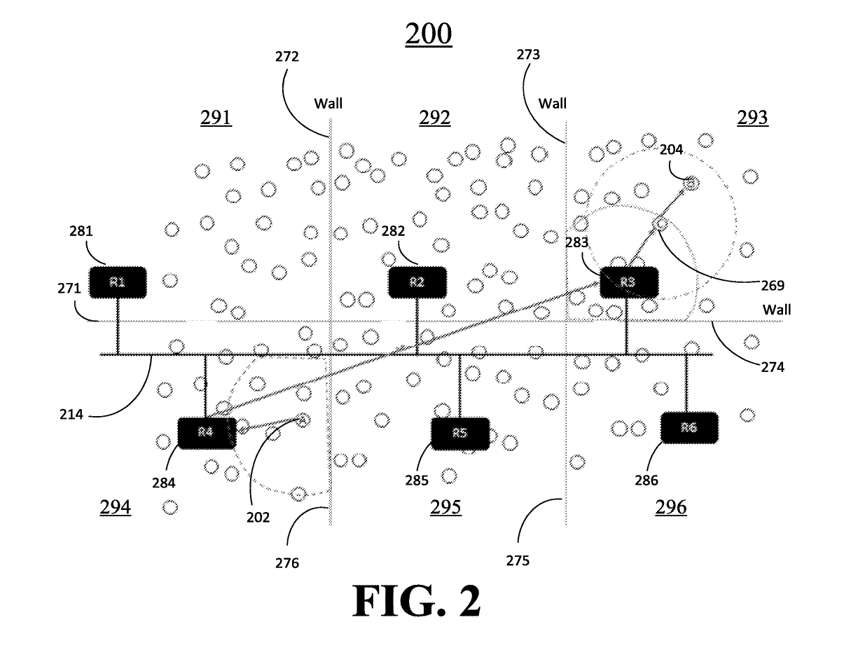

FIG. 2 depicts an example of a system 200 including a plurality of mesh network segments 291-296, in accordance with some example embodiments.

In the example of FIG. 2, each of the mesh networks 291-296 may be separated due to range, a barrier, frequency, and/or some other separation mechanism. In the example of FIG. 2, walls 271-276 separate the mesh networks segments 291-296. The mesh networks segments 291-296 may form a single overall mesh network (in which case 291-296 represent segments or portions of the same overall mesh) or may form separate mesh networks (in which case 291-296 represent individual networks). Furthermore, mesh networks 291-296 may each comprise non-IP mesh networks, in accordance with some example embodiments. Moreover, mesh networks 291-296 may each comprise non-connected mesh networks, in accordance with some example embodiments. For example, the mesh network segments may each represent a Bluetooth or Bluetooth Low Energy mesh network (although other radio technologies may be used as well), and in a given mesh segments packets are forwarded based on an identifier, rather than an IP address. And, the given mesh segments may forward the packets in a non-connected mode, rather than via connected paths.

In some example embodiments, non-IP and/or non-connected mesh network segments 291-296 may each include a router, such as routing nodes 281-286, labeled R1-R6. The routing nodes 281-286 may be coupled via a network 214 (for example, a bus, one or more links, and/or the like) to each other. In some example embodiments, the network/bus 214 may be a single Ethernet link, a Virtual Local Area Network (VLAN), a tunnel established over Internet, an AllJoyn bus, Message Queue Telemetry Transport (MQTT) system, and/or any other type of network, bus, and/or the like.

Furthermore, routing nodes 281-286 may be IP-based (in which case packets are forwarded among routers based on IP addresses), in accordance with some example embodiments. Moreover, routing nodes 281-286 may be in a connected mode, although non-connected mode routers 281-286 may be used as well. In some example embodiments, routers 281-286 are IP-enabled routers selectively forwarding packets obtained from mesh network segments.

To illustrate further, node A 202 in non-IP mesh network segment 294 may transmit a packet destined to node B 204 in non-IP mesh network 293. When this is the case, router 284 (labeled R4) may receive the packet sent by node A 202 and, if the packet is determined to be for a node in another mesh network, router 284 may forward the packet (which may require encapsulating the received packet with a destination IP address for node B 204 or its gateway, router 283).

In some example embodiments, router R4 284 may detect that the destination node 204 is outside the mesh served by router R4 284 by comparing a destination node identifier with all known nodes identifier within mesh network segment 294. Alternatively or additionally, router R4 284 may detect a retransmission of a given packet, which represents the destination node for that packet may not be within mesh network segment 294. Alternatively or additionally, router R4 284 may detect a group address associated with the other mesh network segment 293 in the destination node address of the packet. Alternatively or additionally, router R4 284 may have a forwarding policy determining which packets should be forwarded and to where.

When router R4 284 detects that the destination node B 204 does not belong to mesh network segment 294, router R4 284 may, in accordance with some example embodiments, send a discovery message, such as a Multicast Domain Name System (MDNS) query, to other routers via network/bus 214. The query may be sent as a multicast or broadcast query sent over network/bus 214, although a unicast query may be used as well. In some example embodiments, the discovery message may be in accordance with other formats, standards, and/or protocols, such as Universal Plug and Play (UPnP), AllJoyn, MQTT, multicast Neighbor Discovery/Address Resolution Protocol, and/or the like. Moreover, although network/bus 214 is described as a shared transfer mechanism, such as Ethernet, a virtual local area network, and/or the like, network/bus 214 be a routed network consisting of multiple segments, the Internet, or a combination thereof.

In the case of a MDNS query, the query may include an identifier of the destination node in mesh network 293 to which the packet is being sent. In response to receiving the query including the identifier, router R3 283 may detect that the identifier of the destination node, such as node 204, belongs to mesh network segment 293, which is being served by router R3 283. When this is the case, router R3 283 may respond to the MDNS query with an IP address, such as the IP address of router R3 283. When router R4 284 receives the response from router R3 283 (and/or other routers), router R4 284 may encapsulate the packet sent by node 202 within an IP packet having the destination address as router R3 and the source address as router R4. The router R4 284 may then forward the encapsulated IP packet to remote router R3 283 via network/bus 214. When router R3 283 receives the encapsulated packet, router R3 283 may decapsulate the packet (removing the IP address and the like), and may then forward the decapsulated packet to node B 204 (which may be via other nodes such as node C 269, in the mesh network segment 293).

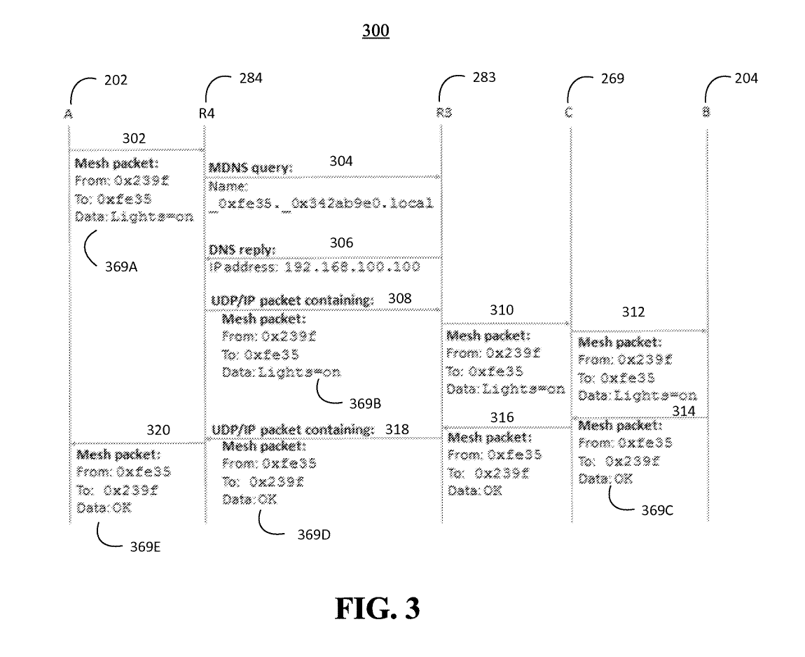

FIG. 3 depicts a signaling diagram for an example process 300 among node A 202, node B 204, router R3 283, and router R4 284, in accordance with some example embodiments. The description of FIG. 3 also refers to FIG. 2.

At 302, node A 202 may send a packet in a mesh network 294, in accordance with some example embodiments. The packet may be sent over the mesh network, which may be a non-IP network and/or a non-connected network, in accordance with some example embodiments. For example, the packet may be transmitted via WiFi, Bluetooth, Bluetooth Low Energy (although other radio technologies may be used) to other peer nodes in mesh network 294. Router R4 284 may receive the packet, and may determine that the destination for the received packet is not in the mesh network 294. For example, the router R4 may detect that an identifier included in the packet does not correspond to a node within mesh 294. In the example of FIG. 3, the data payload 369A of the packet is the original mesh packet including data (“Lights=on”), a source identifier for node 202 (for example, “From: 0x239f”), and a destination identifier for node 204 (for example, “To: 0xfe35”).

Although the previous example depicted the payload 369A as plain text, the payload may also take other forms (for example, binary, look up value, and/or the like). Moreover, the payload may be encrypted as well. Further, the addresses in the previous example (“0x239f” and “0xfe35”). are just that examples as the identifiers can take be of other types, values, and/or sizes.

At 304, router R4 284 may send a query to determine the address of the destination, in accordance with some example embodiments. For example, router R4 284 may generate a hash of an identifier (for example, a mesh network identifier such as “0xfe35,” a key, and/or the like) obtained from the packet and then send a query, such as a discovery message, with the hash of the identifier to one or more other routers 281-283, 285, and 286 via network/bus 214. Although the previous example refers to sending a hash of the identifier, the identifier itself may be sent as well. The query may be sent via broadcast, point-to-point signaling, and/or in other ways as well.

When a router, such as router 283, detects that the identifier is associated with a node in its mesh network segment 293, the router, such as router R3 283, may send a reply message including the IP address of the router serving the mesh (which in this example is the IP address of router R3 283), in accordance with some example embodiments. The reply sent at 306 may be a Domain Name System (DNS) reply.

At 308, router R4 284 may encapsulate the packet received at 302 with the IP address of the router R3 283 serving the destination node, and then send the encapsulated packet to router R3 283, in accordance with some example embodiments. For example, router R4 284 may encapsulate the data payload 369B by adding the destination IP address of the router R3 283 and adding as the source IP address of router R4. Moreover, the packet may be sent in accordance with User Datagram Protocol, although other IP protocols may be used as well.

When remote router R3 283 receives the IP packet sent at 308, router 283 may decapsulate the IP packet and send, at 310, the decapsulated packet over the mesh 293 towards the packet destination, in accordance with some example embodiments. For example, router R3 283 may decapsulate the received IP packet by removing the IP address associated with the source router (which in this example is router R4 284) and destination router (which in this example is router R3 283). The decapsulated mesh packet may then be transmitted at 310 over a mesh network 293 to other nodes. In the example of FIG. 3, node C 269 receives, at 310, the mesh packet and forwards, at 312, the mesh packet via the mesh network 293 to node B 204 (although in some implementations, the packet may be received directly by node B 204 as well).

At 314, node B 204 may send an acknowledgement message (see, for example, “OK” at 369C) to indicate receipt of the data, in accordance with some example embodiments. The acknowledgement message may then traverse back as shown at 316-320. For example, node C 214 may forward, at 316, the acknowledgement message to router R3 283.

At 318, router R3 283 may encapsulate the acknowledgement message within an IP packet and send the IP packet to router R4 284. Router R3 283 may recognize the acknowledgement message as a reply to an earlier packet; if not, router R3 283 may send a MDNS query to determine the destination router that serves the destination address, such as 0x239f 369D. At 320, router R4 284 may decapsulate the acknowledgement message and send the acknowledgement message 369E via mesh network 294 to node A 202.

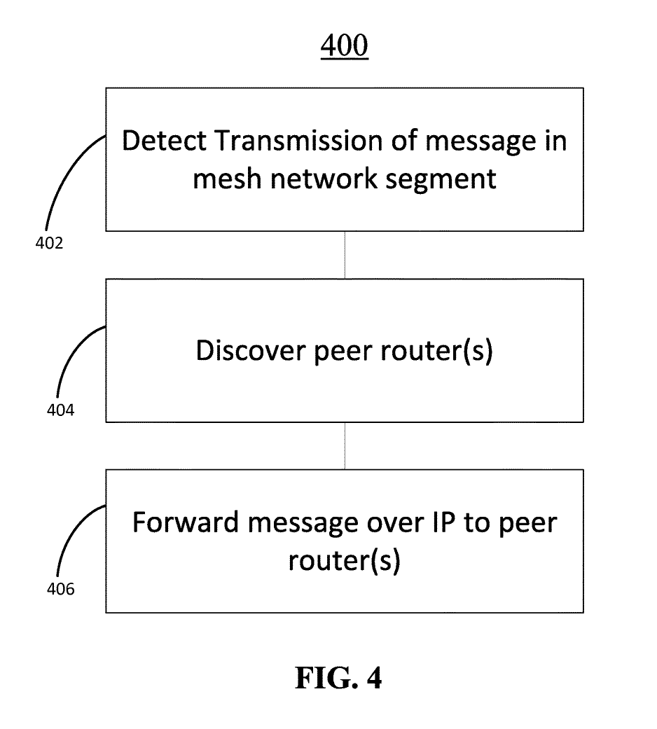

FIG. 4 depicts an example of a process 400 for extending the range of mesh, in accordance with some example embodiments. The description of FIG. 4 also refers to FIG. 2.

At 402, a message may be detected in a first mesh network segment served by a first router that is destined for another node in another mesh network served by a second router, in accordance with some example embodiments. For example, router R4 284 may detect a message, such as mesh packet 369A, with a destination outside of mesh network segment 284.

At 404, the first router may discover one or more peer routers associated with the destination of the message, in accordance with some example embodiments. For example, router R4 284 may query, such as via an MDNS query and/or the like, other routers, such as routers 281-283, 285, and 286 regarding whether the other routers serve the destination indicated by “0xfe35” (or a hash or representation of that value). In this example, router R3 283 may reply, with for example a DNS reply, including the destination IP address of router R3 283, so that router R4 284 can forward, at 406, mesh packet/message 369A as an IP packet to router R3 283, where the IP packet may be decapsulated and forwarded to the destination node 204 via mesh segment 283, in accordance with some example embodiments.

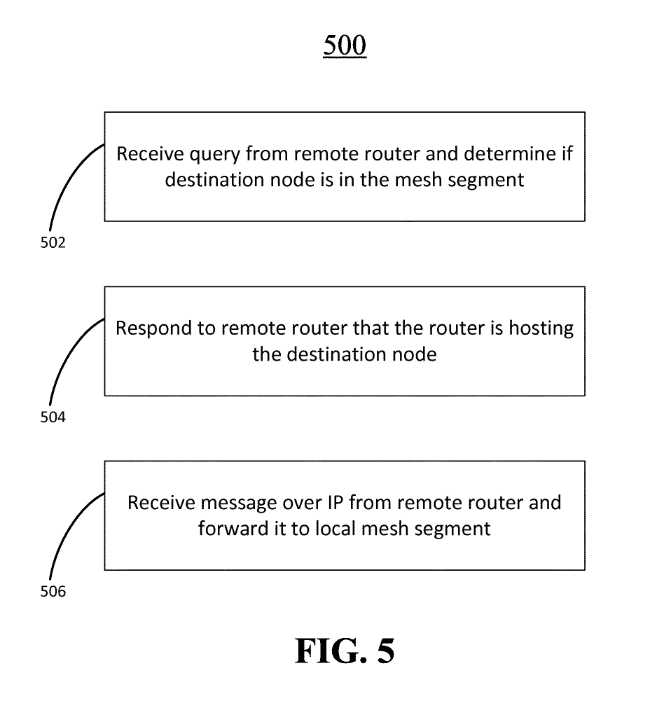

FIG. 5 depicts another example of a process 500 for extending the range of mesh, in accordance with some example embodiments. The description of FIG. 5 also refers to FIGS. 2 and 3.

At 502, a router may receive a query regarding whether the router is associated with (for example, hosts, servers, and/or the like) certain nodes on a mesh network segment, in accordance with some example embodiments. For example, router R4 284 may query router R3 283 whether it is associated with a node at a certain destination, such as destination indicated by “0xfe35” (see, for example, 304 at FIG. 3). At 504, router R3 283 may respond to router R4 284 that router R3 283 is associated with a node at “0xfe35” (see, for example, 306 at FIG. 3). At 506, router R3 283 may receive from router R4 284 the message (for example, 308 where mesh packet 369B is encapsulated by IP source and destination addresses) via IP network/bus 214, and router R3 283 may then forward the received message via the mesh network segment 293.

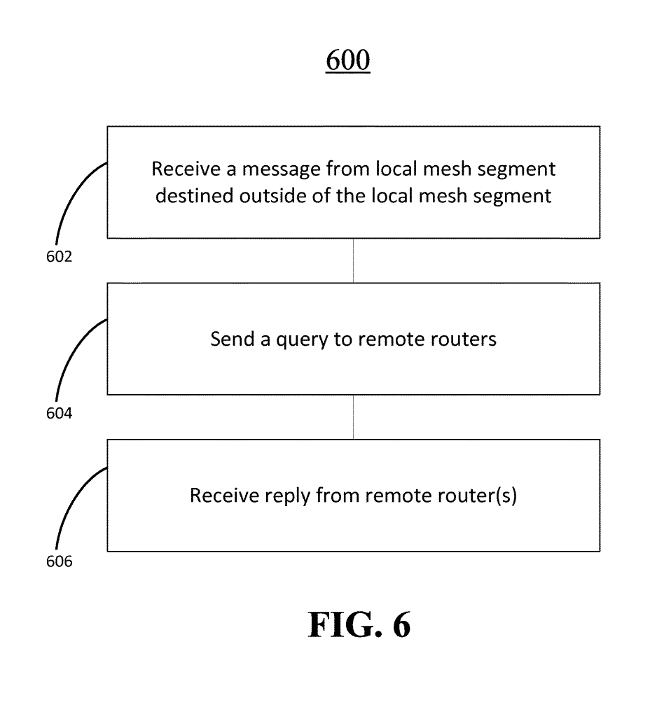

FIG. 6 depicts an example of a process 600 for determining routers hosting mesh nodes, in accordance with some example embodiments. The description of FIG. 6 also refers to FIGS. 2 and 3.

In some example embodiments, router R4 284 may determine that a message is destined for destination node outside of local mesh segment 294. There are several ways to perform the determination. In some example embodiments, router R4 284 may learn the identities of local nodes (for example, nodes within mesh segment 294 served by router 284) by discovering from time to time the local nodes in mesh segment 294 (for example, by sending a local multicast messages within mesh segment 294 requesting the identities of all local nodes). Alternatively or additionally, router R4 284 may learn the identities of local nodes based on the nodes (which are within mesh segment 294) making themselves known to router R4 284 and/or to other nodes which inform router R4 284. Alternatively or additionally, router R4 284 may learn the identities of local nodes based on a static configuration (in which case the nodes in mesh 284 may be statically configured). Alternatively or additionally, router R4 294 may learn the identities of local nodes based on monitoring communications occurring in the local mesh segment 28. This monitoring may also allow router R4 284 to determine that certain nodes belong to a destination or group that is external to mesh segment 294.

At 602, a router may receive a message from local mesh segment, in accordance with some example embodiments. The message may be destined for destination node(s) outside of the local mesh segment. For example, router R4 284 may receive a message in the local mesh network segment 294, and this message may be destined for destination node 204 outside of the local mesh network segment 294. In some example embodiments, router R4 284 may determine, as noted above, that the destination node(s) does not belong to the local mesh network segment. Alternatively or additionally, router R4 284 may determine, as noted above, that the destination nodes belongs to a group outside of the local mesh network segment. Alternatively or additionally, router R4 284 may determine by policy that received packet is destined outside of the local mesh network.

At 604, the router may send a query to remote routers, in accordance with some example embodiments. For example, router R4 284 may send a query, such as a MDNS, with a resource request to the network/bus 214. In some example embodiments, the resource request may include resource record type in the MDNS. The resource record type may be an address record (A record), an IP version 6 address record (AAAA record), a service record (SRV, see for example, RFC-2782), a pointer record (PTR) record, or the like. In some example embodiments, the IP address and port information may be used as a destination address where the message may be forwarded. In some example embodiments, a name is included in the query. The name may be formed by combining the identity of the target node with the identity of the mesh network segment and appending a suitable suffix, such as “.local”. In some example embodiments, the identities may be true identities or hashes calculated from true identities. For example, if node A 202 (for example, has an ID 0x239f) is sending data to node B 204 (for example, has an ID 0xfe35), router R4 284 may create a name based on node A 202's ID. Router R4 284 may calculate a hash 0x342ab9e0 (e.g., 64-bit hash of mesh network identifier based on the mesh network segment of node A) and concatenate into a name (for example, _0xfe35._0x342ab9e0.local). In some example embodiments, if the destination includes all nodes in a mesh network segment, the query can include a name destined to all nodes in the mesh network (for example, _all. _0x342ab9e0.local).

Router R3 283 may receive the MDNS query and then calculate hash values from identifiers (for example, UUIDs) of the nodes or mesh networks router R3 283 is serving. If the hash values match a node or mesh network segment that router R3 283 is serving, router R3 283 may send a positive MDNS reply on the shared network/bus 214 with router R3's IP address and port number(s).

At 606, the router may receive reply from remote router(s), in accordance with some example embodiments. For example, router R4 284 may receive positive MDNS replies from all routers (which are coupled to the shared network/bus 214) that determine they have destination node(s) in their local mesh network segments or that mesh identifier matches.

In some example embodiments, two or more routers may receive the same message from a node in a mesh network, for example a first router and a second router. The first router may receive the message from the node and discover that the second router is serving node in the destination group. In some example embodiment, the first node may include sender information in the discovery message. For example, the MDNS query may include source information, such as “_0x239f._0xfe35._0x342ab9e0”. The second router may determine that the sender belongs to the mesh network that the second router being served. In another example embodiment, the first router may include sender's address in the forward message to the second router. The second router may discard the forwarded message if the sender is a node in its local mesh network segment.

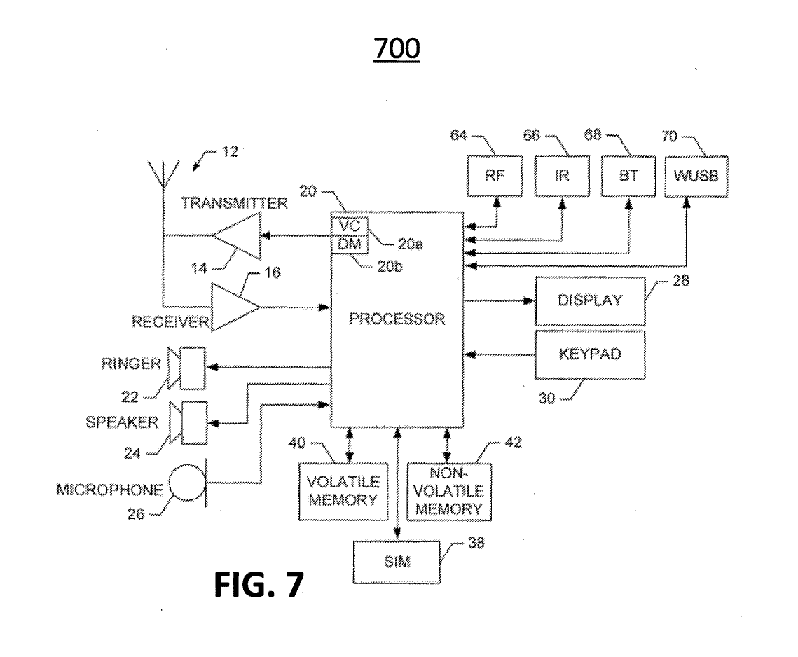

FIG. 7 depicts an example of an apparatus 700, in accordance with some example embodiments. The apparatus 700 may comprise node, such nodes 202, 269, 204, and/or the like. Moreover, the nodes may comprise a user equipment, such as an internet of things device (for example, a machine, a sensor, an actuator, and/or the like), a smart phone, a cell phone, a wearable radio device (for example, an IoT fitness sensor or other type of IoT device), and/or any other radio based device. The routers R1-R6 281-286 may also include some (if not all) of the aspects noted below with respect to apparatus 700 to enable among other things communicating with nodes and/or discovering other routers associated with certain nodes.

In some example embodiments, apparatus 700 may also include a radio communication link to a cellular network, or other wireless network. The apparatus 700 may include at least one antenna 12 in communication with a transmitter 14 and a receiver 16. Alternatively transmit and receive antennas may be separate.

The apparatus 700 may also include a processor 20 configured to provide signals to and from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 700 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Apparatus 700 may include a location processor and/or an interface to obtain location information, such as positioning and/or navigation information. Accordingly, although illustrated in as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as, Institute of Electrical and Electronics Engineers (IEEE) 802.11, 802.16, and/or the like. In addition, these signals may include speech data, user generated data, user requested data, and/or the like.

The apparatus 700 may be capable of operating with one or more air interface standards, communication protocols, modulation types, access types, and/or the like. For example, the apparatus 700 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 700 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 700 may be capable of operating in accordance with 2.5G wireless communication protocols General Packet Radio Service (GPRS), Enhanced Data GSM Environment (EDGE), and/or the like. Further, for example, the apparatus 700 may be capable of operating in accordance with 3G wireless communication protocols, such as, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 700 may be additionally capable of operating in accordance with 3.9G wireless communication protocols, such as, Long Term Evolution (LTE), Evolved Universal Terrestrial Radio Access Network (E-UTRAN), and/or the like. Additionally, for example, the apparatus 700 may be capable of operating in accordance with 4G wireless communication protocols, such as LTE Advanced and/or the like as well as similar wireless communication protocols that may be subsequently developed.

It is understood that the processor 20 may include circuitry for implementing audio/video and logic functions of apparatus 700. For example, the processor 20 may comprise a digital signal processor device, a microprocessor device, an analog-to-digital converter, a digital-to-analog converter, and/or the like. Control and signal processing functions of the apparatus 700 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 700 to perform actions. For example, processor 20 may be capable of operating a connectivity program, such as, a web browser. The connectivity program may allow the apparatus 700 to transmit and receive web content, such as location-based content, according to a protocol, such as, wireless application protocol, wireless access point, hypertext transfer protocol, HTTP, and/or the like.

Apparatus 700 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 700 may include a battery for powering various circuits related to the mobile terminal, for example, a circuit to provide mechanical vibration as a detectable output. The user input interface may comprise devices allowing the apparatus 700 to receive data, such as, a keypad 30 (which can be a virtual keyboard presented on display 28 or an externally coupled keyboard) and/or other input devices.

Moreover, the apparatus 700 may include a short-range radio frequency (RF) transceiver and/or interrogator 64, so data may be shared with and/or obtained from electronic devices in accordance with RF techniques. The apparatus 700 may include other short-range transceivers, such as an infrared (IR) transceiver 66, a Bluetooth (BT) transceiver 68 operating using Bluetooth wireless technology, a wireless universal serial bus (USB) transceiver 70, and/or the like. The Bluetooth transceiver 68 may be capable of operating according to low power or ultra-low power Bluetooth technology, for example, Wibree, Bluetooth Low-Energy, and other radio standards. In this regard, the apparatus 700 and, in particular, the short-range transceiver may be capable of transmitting data to and/or receiving data from electronic devices within a proximity of the apparatus, such as within 10 meters. The apparatus 700 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 700 may comprise memory, such as, a subscriber identity module (SIM) 38, a removable user identity module (R-UIM), and/or the like, which may store information elements related to a mobile subscriber. In addition to the SIM, the apparatus 700 may include other removable and/or fixed memory. The apparatus 700 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the nodes and/or routers disclosed herein. The memories may comprise an identifier, such as an international mobile equipment identification (IMEI) code, capable of uniquely identifying apparatus 700. The functions may include one or more of the operations disclosed herein including with respect to the nodes and/or routers disclosed herein (see for example, 300, 400, 500, and/or 600). The memories may comprise an identifier, such as an international mobile equipment identification (IMEI) code, capable of uniquely identifying apparatus 700. In the example embodiment, the processor 20 may be configured using computer code stored at memory 40 and/or 42 to provide the operations, such as detecting, by a router coupling a first mesh network to at least one other mesh network, a mesh packet having a destination node in the at least one other mesh network; receiving, at the router, an internet protocol address of the at least one other router, wherein the internet protocol address is received in response to querying for the destination node; and sending, by the router, the mesh packet encapsulated with the internet protocol address of the at least one other router coupled to the at least one other mesh network including the destination node.

Some of the embodiments disclosed herein may be implemented in software, hardware, application logic, or a combination of software, hardware, and application logic. The software, application logic, and/or hardware may reside in memory 40, the control apparatus 20, or electronic components disclosed herein, for example. In some example embodiments, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry. A computer-readable medium may comprise a non-transitory computer-readable storage medium that may be any media that can contain or store the instructions for use by or in connection with an instruction execution system, apparatus, or device, such as a computer. Furthermore, some of the embodiments disclosed herein include computer programs configured to cause methods as disclosed with respect to the nodes and/or routers disclosed herein (see for example, 300, 400, 500, and/or 600).

Without in any way limiting the scope, interpretation, or application of the claims appearing below, a technical effect of one or more of the example embodiments disclosed herein is to transmit packets among different mesh network segments.

Without in any way limiting the scope, interpretation, or application of the claims appearing below, another technical effect of one or more of the example embodiments disclosed herein is enhanced operation with respect to the splitting a mesh network into smaller segments.

Without in any way limiting the scope, interpretation, or application of the claims appearing below, another technical effect of one or more of the example embodiments disclosed herein is to discover remote routers in a non-IP non-connected mesh network.

The subject matter described herein may be embodied in systems, apparatus, methods, and/or articles depending on the desired configuration. For example, the systems, apparatus, methods, and/or articles described herein can be implemented using one or more of the following: electronic components such as transistors, inductors, capacitors, resistors, and the like, a processor executing program code, an application-specific integrated circuit (ASIC), a digital signal processor (DSP), an embedded processor, a field programmable gate array (FPGA), and/or combinations thereof. These various example embodiments may include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the example embodiments described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

1-17. (canceled)

18. A method comprising:
detecting, by a router coupling a first mesh network to at least one other mesh network, a mesh packet having a destination node in the at least one other mesh network;
receiving, at the router, an internet protocol address of at least one other router, wherein the internet protocol address is received in response to querying for the destination node; and
sending, by the router, the mesh packet encapsulated with the internet protocol address of the at least one other router coupled to the at least one other mesh network including the destination node.

19. The method of claim 18, wherein the mesh packet traverses the first mesh network based on an identifier identifying the node, rather than an internet protocol address.

20. The method of claim 19, wherein the identifier comprises at least one of a universally unique identifier, a media access control address, a shared key, or a personal area network identifier.

21. The method of claim 18, wherein the sending the mesh packet encapsulated with the internet protocol address further comprises:
sending, via an internet protocol, the encapsulated mesh packet to the at least one other router.

22. The method of claim 18 further comprising:
querying, by the router, at least one other router to determine the destination node.

23. The method of claim 18 further comprising:
encapsulating, by the router, the mesh packet by adding the internet protocol address of the at least one other router.

24. The method of claim 18, wherein the internet protocol address of the at least one other router is received via a domain name system reply, and wherein the query further comprises sending a domain name system query including an identifier for the destination.

25. An apparatus, comprising:
at least one processor; and
at least one memory including computer program code, the at least one memory and the computer program code configured to, with the at least one processor, cause the apparatus to perform at least the following:
detect, by the apparatus coupling a first mesh network to at least one other mesh network, a mesh packet having a destination node in the at least one other mesh network;
receive, at the apparatus, an internet protocol address of at least one other apparatus, wherein the internet protocol address is received in response to querying for the destination node; and
send, by the apparatus, the mesh packet encapsulated with the internet protocol address of the at least one other apparatus coupled to the at least one other mesh network including the destination node.

26. The apparatus of claim 25, wherein the mesh packet traverses the first mesh network based on an identifier identifying the node, rather than an internet protocol address.

27. The apparatus of claim 26, wherein the identifier comprises at least one of a universally unique identifier, a media access control address, a shared key, or a personal area network identifier.

28. The apparatus of claim 25, wherein the apparatus is further configured to at least send, via an internet protocol, the encapsulated mesh packet to the at least one other apparatus.

29. The apparatus of claim 25 wherein the apparatus is further configured to at least query at least one other apparatus to determine the destination.

30. The apparatus of claim 25, wherein the apparatus is further configured to at least encapsulate the mesh packet by adding the internet protocol address of the at least one other apparatus.

31. The apparatus of claim 25, wherein the internet protocol address of the at least one other apparatus is received via a domain name system reply, and wherein the query further comprises sending a domain name system query including an identifier for the destination.

32. The apparatus of claim 25, wherein the apparatus comprises at router, and wherein the at least one other apparatus comprises at least one other router.

33. A non-transitory computer-readable storage medium including program code which when executed by at least one processor causes operations comprising:
detecting, by a router coupling a first mesh network to at least one other mesh network, a mesh packet having a destination node in the at least one other mesh network;
receiving, at the router, an internet protocol address of at least one other router, wherein the internet protocol address is received in response to querying for the destination node; and
sending, by the router, the mesh packet encapsulated with the internet protocol address of the at least one other router coupled to the at least one other mesh network including the destination node.
